(19) United States
(12) Patent Application Publication
(10) Pub. No.: US 2009/0150540 A1
(43) Pub. Date: Jun. 11, 2009

(54) Method for identifying components in a network

(76) Inventors: Victor Traub, Yehud (IL); Fedor Losev, Holon (IL)

Correspondence Address: Pearl Cohen Zedek Latzer, LLP, 1500 Broadway, 12th Floor, New York, NY, 10036, US

(21) Appl. No.: 11/987,840

(22) Filed: Dec. 5, 2007

(51) Int. Cl. G06F 15/16

(52) U.S. Cl. 709/224

(57) ABSTRACT

A method of identifying components in a network path by defining a role for a component from a rule governing another component or the network path, and identifying an instance of such first component from a data base listing instances of the component and associations of such component with other components in the path.

### FIELD OF THE INVENTION

The present invention generally relates to network configurations. More particularly, the present invention relates to a system and method for identifying components that may be connected in a path of a network configuration.

### BACKGROUND OF THE INVENTION

A network such as for example a communications network may include numerous components, which may serve pre-defined functions in the network and which may communicate with each other over pre-defined communication protocols over one or more of several possible paths.

In managing a network, an administrator may desire to identify the components involved in carrying one or more particular communication signals and the protocols or other relationships that may be used between such components. A user may want to identify testing procedures and repair-processes that are appropriate for the components, links and protocols used in such path.

### SUMMARY OF THE INVENTION

Some embodiments of the invention include defining a role of a second component in a network, through the use of a pre-defined rule about a first component in the network; and identifying an instance of the second component by accessing a data base that includes the role of the second component and the instance of the second component, where the instance is associated in the data base with the first component.

Some embodiments include determining a relationship among the first component and the second component, by accessing a data base listing the first component, the instance of the second component and the relationship.

In some embodiments a process is executed recursively for example until an instance is determined for each of the components connecting the first component and the second component, and a relationship is determined for each of the plurality of components connecting the first component and the second component.

In some embodiments the first component may be or include a connection of an end user to a network.

Some embodiments include accepting input about a problem in the network; and identifying a diagnostic process to test a connection between two components, where identifying the diagnostic process includes accessing a data base listing the first component, the second component, and the diagnostic process, where the diagnostic process is associated in the data base with one or more of the first component, the second component and the problem.

Some embodiments include identifying a repair process to correct the problem, where the identifying is done on a data base that includes the repair process, and the data base includes an association of the repair process with a component of the network.

Some embodiments include accepting data about a problem in the network; and identifying a process to correct the problem, where the identifying includes accessing a data base listing the first component, the second component, the problem and the process.

Some embodiments include displaying a path on a network, where displaying such path includes displaying an indication of a first component in the path; displaying an indication of a second component in the path, where the second component is defined by a rule applied to the first component; and displaying an indication of an instance of the second component, where the instance is derived from an association of the second component with an instance of the first component.

In some embodiments displaying the indication of the second component and displaying an indication of the instance of the second component, are executed recursively.

Some embodiments include identifying a diagnostic to test the second component, and displaying an indication of a failure of that component.

Some embodiments include identifying a repair process for the component wherein a problem was found.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a system in accordance with an embodiment of the invention;

FIG. 2 is a rule compendium in accordance with an embodiment of the invention;

FIG. 3A is a simplified depiction of a service exploration chart, with a role for a first component defined thereon, in accordance with an embodiment of the invention;

FIG. 3B is a simplified depiction of a service exploration chart, with a role for a first component and a set of customer edges defined thereon, in accordance with an embodiment of the invention;

FIG. 3C is a simplified depiction of a service exploration chart, with a role for a first component, a set of customer edges and a set of provider edges defined thereon, in accordance with an embodiment of the invention;

FIG. 3D is a simplified depiction of a service application chart with roles defined for one or more relationships between components, for a diagnostic process on a connection between components and for a repair procedure that may be implemented to fix a diagnosed failure of a network path, in accordance with an embodiment of the invention;

FIG. 4 is a schematic depiction of fields of a data base listing possible components, protocols, diagnostics and repair procedures that may be present or used in a network path, in accordance with an embodiment of the invention;

FIG. 5 is a flow chart of a method in accordance with an embodiment of the invention; and

FIG. 6 is a flow chart of a method of a presenting a display of a network exploration chart in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In some embodiments, the term “association” may, in addition to its ordinary meaning, imply an indication in a structured data storage, such as a data base, of a link between an entry in one field of such data base, and an entry in the same or another field of such data base.

The processes and functions presented herein are not inherently related to any particular computer, network or other apparatus. Embodiments of the invention described herein are not described with reference to any particular programming language, machine code, network etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention. Embodiments of the invention may be implemented in fields unrelated to computer networks, such as for example in social networks, traffic, transportation and railway networks, electric or other utility networks, chemical, molecular or physical structures, genetic studies, or other fields of endeavor that include multiple possible components that may be related in pre-defined ways.

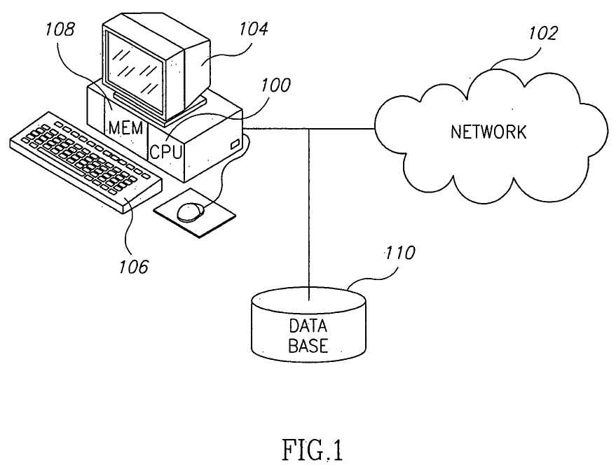

Reference is made to FIG. 1, a schematic diagram of a system in accordance with an embodiment of the invention. In some embodiments a system may include a processor 100 that may be connected to or included in a computer such as a personal computer or client of a network 102. Processor 100 may be linked to or included in a computer system that may include for example a display 104, one or more input devices 106 such as a key board or mouse, a memory 108 such as a memory that includes a structured storage or other data base 110, a network connection and other devices as may be used by for example a customer service representative or by a network administrator or manager. In some embodiments, processor 100 and data base 110 may be part of or linked to network 102. Network 102 may be or include for example a local area network, a wide area network, a data, cable tv, voice, power, water, supply, gas, transport or video network or other network or configuration of linked components. Network 102 may include components such as for example modems, servers, routers, gateways, edges, providers and communication lines. Other components that may be included in a network are possible.

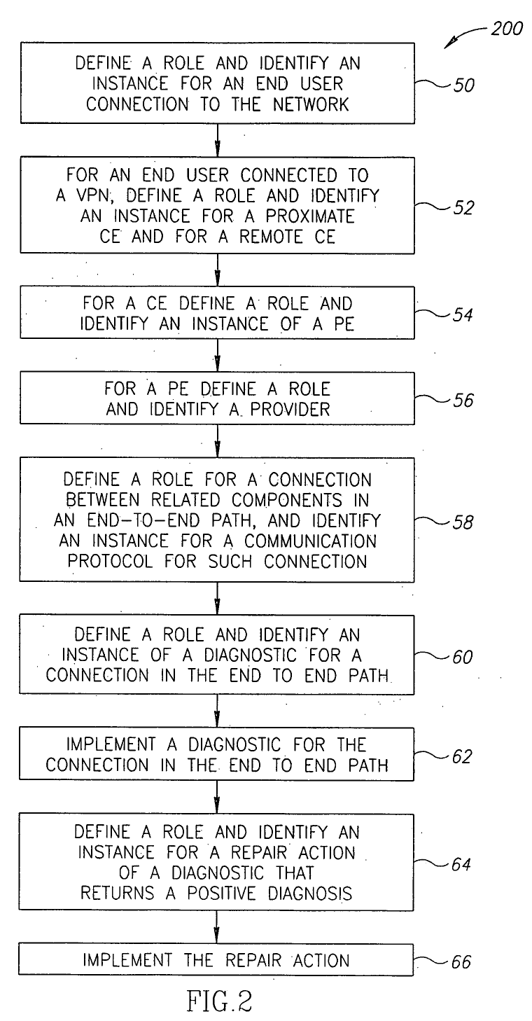

Reference is made to FIG. 2, a rule compendium in accordance with an embodiment of the invention. In some embodiments, rule compendium 200 may include one or a series of instructions that may be executed by for example a processor 100 or some other processor. In some embodiments, one or more rules in rule compendium 200 may be executed in one or more stages, and may at one or more stage prompt a user such as a network manager or customer service representative to respond to a query. In some embodiments, rule compendium 200 may interact with or draw data from data base 110. In some embodiments, a response to or action taken in response to a rule may be determined by data received from data base 110. In some embodiments, an execution of a rule may result in accessing a field of data base 110, and in a selection of an instance from such field.

In operation, rule compendium 200 may include one or more rules for exploring or defining one or more network connections or paths over which a signal or other item may be conveyed in a network configuration from for example one point to another on the network 102. In some embodiments, the exploration may progress by defining roles for components of the network on the basis of the rules in rule compendium 200. For one or more of such defined roles, data base 110 may be accessed to identify one or more possible instances of the component that exists for the defined role, and then to select a particular instance that may be associated with or otherwise relevant in light of the path or of the prior instances of components that may have been selected. A process of defining a role and identifying an instance for the role may proceed until for example some or all of the roles for the relevant components have been defined and added to the assembled path, and the instances of the components filling such roles have been identified. In some embodiments the defined roles and identified instances may be stored in one or more of a logical or graphic format. In some embodiments a graphic format that may include defined roles and identified instances may be displayed on display 104, and a user may be able to direct processor 100 to implement actions based on the displayed roles and instances.

In some embodiments, additional roles may be defined for relationships or connections between one or more of the identified components. Such relationships may include for example physical links between the components, such as communication links, or logical links such as communication protocols to which communication signals between the components may conform. In some embodiments, a processor 100 may access one or more data bases 110 to determine an instance of a protocol pursuant to which two or more components may exchange signals.

In some embodiments processor 100 may define a role for one or more diagnostic procedures that may be implemented to check for example an operational status of one or more relevant components or connections that are defined and instantiated, and processor 100 may issue a signal to implement such diagnostic procedures.

In some embodiments, processor 100 may receive an indication or signal that a diagnostic has located a source of a problem with one or more of the identified components or links. Processor 100 may access data base 110 for one or more repair procedures that may be recommended or associated with the diagnosed problem to repair the problem or take compensatory measures. In some embodiments, a role may be defined for the repair measure and data base 110 may be accessed to define an instance for the repair role.

In some embodiments, a definition of a role may be coupled or associated with an instruction to processor 100 to select a field of data base corresponding with such role, and to look for an instance of such field that is associated with one or more other roles or instances in the path.

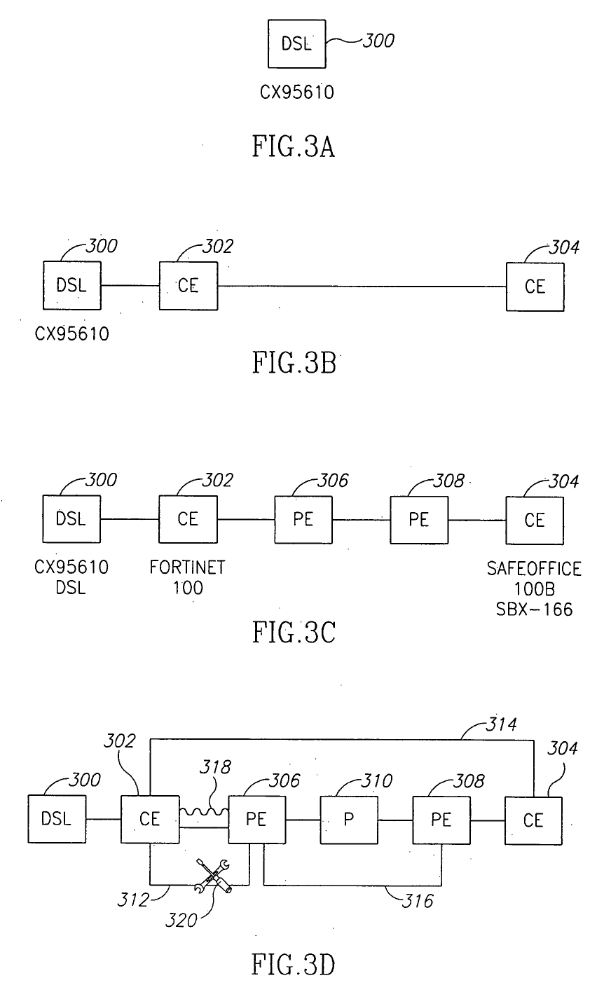

Reference is made to FIG. 3A, a simplified depiction of a service exploration chart, with a role for a first component defined thereon, in accordance with an embodiment of the invention. In some embodiments, and referring also to block 50 of FIG. 2, a component 300 connected to a communication network may be identified and for example accepted by processor 100. In some embodiments, such component 300 may be a first component, and may be identified by for example a user of the network who notices a problem with the network. A user may provide for example a customer service number or other identifying data about the component 300, possibly without specifically identifying the first component 300.

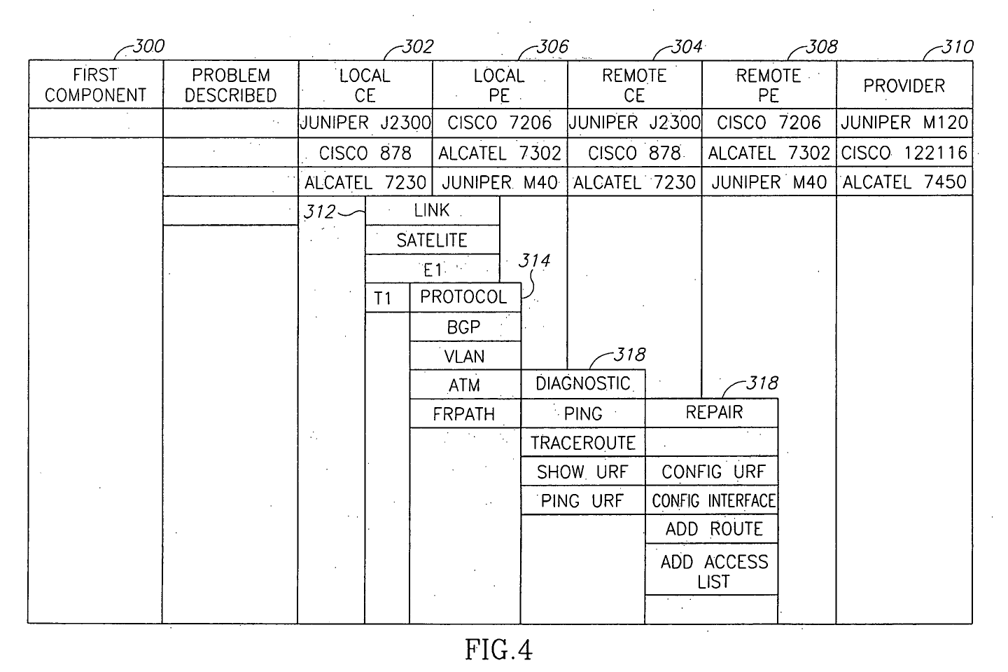

Processor 100 may define a role for first component 300 on for example a service exploration chart. In some embodiments, processor 100 may access data base 110 to collect data, such as brand, model, service type, serial or other identification number about component 300, its use or situation relative to the network path being explored. Such data may be added or linked to the defined role for the first component 300. For example, an input of a customer service ID number 1234567, may indicate that the customer receives 1.5 mega service with a link through a VPN. Data base 110 may also indicate that the user is linked to the network with a CX95610 modem, and this instance of the role of component 300 may be added to the service exploration chart. Data about a first component that may be added to a service exploration chart may be known from sources other than a user. In some embodiments, and referring to FIG. 4, a field for first component may be added to a query about the path being explored, and such field may be presented on display 104. Processor 100 may select the instance of component 300 from the field.

Continuing the example from above, processor 100 may also accept data about the kind of problem that is being experienced by the user relating to the network. For example, “the connection between my modem in NY over the VPN with our Chicago office is too slow.”

Returning to block 52 of FIG. 2, a rule may indicate that for components connected as part of a VPN, a role is to be created for a local or proximate customer edge (CE) 302 to which the first component 300 is connected, in this case the CE in the New York office, and for a remote CE 304 to which a remote connection of the VPN is connected, in this case the CE 304 of the office in Chicago. A processor 100 may add or define the two roles on the service exploration chart, may select the field CE from data base 110, and may consult data base 110 to determine an instance of the proximate CE 302 that is used in the New York office of the user, and an instance for the remote CE 304 that is used in the Chicago office of such user. A field from data base 110 for the proximate CE 302 and the remote CE 304 may be added to a display as appears in FIG. 4, and data base 110 may be accessed to find the instance for the make, brand or other identifying information about CE 302 and about CE 304 that are associated with component 300. Information about the instance may be added to the service exploration chart. For example, data base 110 may indicate that the proximate CE 302 is a Fortinet 100, and the remote CE 304 is a Safeoffice series 100b SBX-166, and an indication of such instances may appear on the service exploration chart.

Returning to block 54 of FIG. 2, a rule may indicate that a further role must be defined for one, some or each CE, such that the CE must be connected to one or more provider edges (PE). In this case, and referring to FIG. 3C, a first or local PE 306 may be added to the service exploration chart and linked to CE 302, and another or remote PE 308 may be added and linked to CE 304. Processor 100 may access data base 110 to determine a particular brand, model or other identifying information for PE 306 and PE 308 that are associated with the proximate CE 302 and remote CE 304, respectively, and as is shown in FIG. 3C, such instance information may be stored in a memory and/or added to a depiction of the service exploration chart.

Moving to Block 56 of FIG. 2, a rule may dictate that a PE 306 must be connected to one or more providers 310, and a role for the provider 310 may be defined and added to a service exploration chart. Data base 110 may be accessed to obtain information about the particular provider 310 to which PE 306 connects, and, referring to FIG. 4, a field for provider 310 may be added to a chart for finding an instance of provider 310.

In some embodiments, a rule may dictate that all components in an end-to-end communication link between one user of a network, such as a user of a VPN, and another end of the VPN need to be included in a service exploration chart. Processor 100 may recursively perform a process of adding a role to the chart and accessing a data base 110 to define an instance of a make, brand, model or other identification of the component in the particular role on the chart until such rule is satisfied, and until all instances of components in the end to end connection are identified. Other termination triggers may be used to end an exploration of a network path.

Moving to block 58, a rule may dictate that some or all of the components on a service explorer graph must be connected by a defined relationship. For example, and referring to FIG. 3E, a rule may dictate that one or more of a logical link such as a communication protocol 314, and a physical link such as a connection 312, must be defined between two components that make up a relevant connection in a communication network, such as for example in an end to end connection. Processor 100 may then define a role for a link or connection 312 between two components, and may access data base 110 to determine an instance of a communication connection 312 or protocol 314 by which for example a particular CE 302 communicates with a particular PE 306, or by which one CE 302 links to another CE 304 or to a provider 310. In some embodiments, an indication of protocol 314 that may be used for communication between two or more components may be added to a service exploration chart as is indicated in FIG. 3D. In some embodiments, data base 110 may be accessed to select the field of protocols and to identify or instantiate the relevant protocol 314 and connection 312 that may be present in the connection between CE 302 and CE 304. Data on such protocol 314 and connection 312 or connection 316 may be inserted into the service exploration chart and into the added field in FIG. 4, as an instance of the created role.

Moving to Block 60 of FIG. 2, a rule may instruct a processor to define a role for one or more diagnostic tests 318 for relevant components or relevant connections 312 on the service exploration chart. In block 62, processor 100 may implement the diagnostic or test procedure for one or more of the components or connections between relevant components in a network communication link. In some embodiments, processor 100 may access a database 110 that may list a diagnostic test 318 or troubleshooting procedure, such as for example a ping procedure, that may be used as a test for a connection between two components whose roles may have been defined and for which diagnostics may have been instantiated. For example, a role for a diagnostic test 318 may be added between CE 302 and PE 306. An instance for such diagnostic test 318 may be looked up by accessing data base 110, and processor 100 or some other processor may execute diagnostic test 318 on such component. An indication of diagnostic test 318 may be added to service exploration chart and to a display of the roles defined and instances created as appear on FIG. 4. Diagnostics may be executed recursively on some or all of the relevant components or links in a path until some or all of the components or links have been tested.

Moving to Block 64 of FIG. 2, in some embodiments, processor 100 may collect responses from the diagnostic procedures that were performed, and may define a role for repair services 320 that are to be performed on one or more of the components or links that were found to need repair or attention. Referring to Block 66 of FIG. 2, a role for a repair service 320 may be added to a service exploration chart, and an instance for the repair process may be selected from for example data base 110 to match the required repair role to the diagnosed problem and the subject components. Referring to FIG. 4, a field for the repair service may be added on a display of fields for defined roles, and an instance of the repair service that may be associated with the diagnostic may be identified from such field.

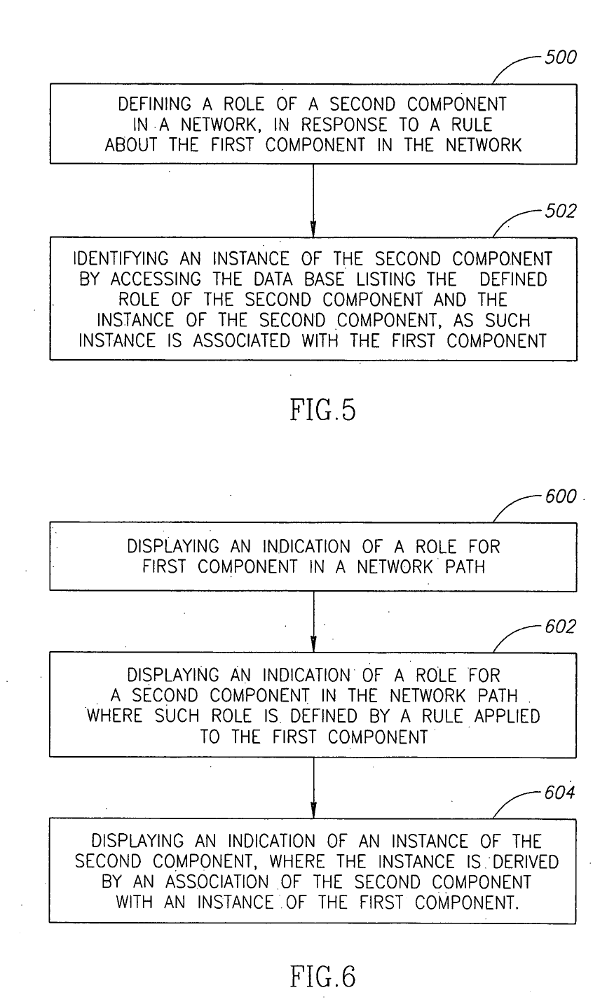

Reference is made to FIG. 5, a flow chart of a method in accordance with an embodiment of the invention. In block 500, a processor may define a role of a component of a network in response to a pre-defined rule about another component in the network. The pre-defined rule may for example be applied to a component that is identified by an outside source, such as a first component about which a customer service call may have been made, or by a another trigger. In block 502, a processor may identify an instance of a component for which the role was defined, by for example accessing a field in a data base that may include several instances of the second component, and finding the instance of such component that is associated with the first component.

In some embodiments, a method may include determining a relationship between the first or some other component, and the second component, where the relationship may for example be or include a physical or communication link between the components or for example a protocol used for communication between the components, and where such determining may include accessing a data base that includes the two components and finding an instance for the relationship.

The process may be repeated, for example recursively until roles for some or all of the components in a path on a network have been identified. Similarly, a recursive execution may define a role for one or more relationships between components in the path, and may identify instances for the relationships.

In some embodiments, a role for a diagnostic process to test a connection between two or more components may be defined, and a data base of diagnostics that are associated with the components may be accessed to find an instance of the diagnostic.

In some embodiments, a processor may accept data about a problem on a network path, and may identify a process to correct the problem, where the identifying includes accessing a data base that may list one or more components that were identified, and a repair process that is associated with the components and the identified problem.

Reference is made to FIG. 6, a flow chart of a method of displaying an exploration chart of a network path in accordance with an embodiment of the invention. In some embodiments, the invention may include a method of displaying a path on a network. In block 600, a method may include displaying an indication of a first component in the path. In block 602, a method may include displaying an indication of a second component in the path, where the role of the display of the second component is defined by a rule that is applied to the first component. In block 604, the method may include displaying an indication of an instance of the second component, where the instance of the second component is identified by an association in a data base of the instance of the first component to the role defined by the second component.

In some embodiments, there may be displayed an indication of the second component that may include an indication of the instance of the second component.

In some embodiments, there may be identified a diagnostic to test the second component or a link to the second component, and there may be displayed an indication of a failure of the component or link.

In some embodiments, a method may include displaying an indication of a repair process that may be associated with one or more of a component that was identified in a network path, a problem that was identified in a network path, and a link that was identified in a network path.

It will be appreciated by persons skilled in the art that embodiments of the invention are not limited by what has been particularly shown and described hereinabove. Rather the scope of at least one embodiment of the invention is defined by the claims below.

We claim:

1. A method comprising:
defining a role of a second component in a network, said defining in response to a pre-defined rule about a first component in a network; and
identifying an instance of said second component by accessing stored data that includes said role of said second component and said instance of said second component, said instance being associated in said stored data with said first component.

2. The method as in claim 1, comprising determining a relationship among said first component and said second component, wherein said determining comprises accessing said stored data listing said first component, said instance of said second component and said relationship.

3. The method as in claim 1, wherein defining and identifying are executed recursively.

4. The method as in claim 3, wherein said method is executed recursively until an instance is determined for each of a plurality of components connecting said first component and said second component, and a relationship is determined for each of said plurality of components connecting said first component and said second component.

5. The method as in claim 1, wherein said first component comprises a connection of an end user to a network.

6. The method as in claim 1, comprising:
accepting input about a problem in said network; and
identifying a diagnostic process to test a connection between said first component and said second component, said identifying of said process comprising accessing stored data listing said first component, said second component, said diagnostic process being associated in said stored data with said second component.

7. The method as in claim 6, comprising identifying a repair process to correct said problem on a data base including said diagnostic process and an association in said stored data of said repair process with a component of said network.

8. The method as in claim 1, comprising:
accepting data about a problem in said network; and
identifying a process to correct said problem, said identifying said process comprising accessing stored data listing said first component, said second component, said problem and said process.

9. A method of displaying a path on a network comprising:
displaying an indication of a known first component in said network path;
displaying an indication of a second component in said path, said second component defined by a rule applied to said first component; and
displaying an indication of an instance of said second component, said instance derived from an association in stored data of said second component with an instance of said first component.

10. The method as in claim 9, wherein said displaying said indication of said second component and said displaying an indication of said instance of said second component are executed recursively.

11. The method as in claim 9, comprising identifying a diagnostic to test said second component, and displaying an indication of a failure of said component.

12. The method as in claim 9, comprising identifying a repair process for said second component.
